(19) United States
(12) Patent Application Publication
(10) Pub. No.: US 2026/0000032 A1
(43) Pub. Date: Jan. 1, 2026

(54) POT FOR A PLANT

(71) Applicant: PERKYPOD PTY LTD, NEW SOUTH WALES (AU)

(72) Inventor: LOUISE JULIE BURR, NEW SOUTH WALES (AU)

(21) Appl. No.: 18/992,938

(22) PCT Filed: Jul. 4, 2023
(86) PCT No.: PCT/AU2023/050618

§ 371 Date: Jan. 9, 2025

(30) Foreign Application Priority Data
Jul. 12, 2022 (AU) 2022901934

(51) Int. Cl. A01G 9/02; A01G 9/04

(52) U.S. Cl. CPC A01G 9/028; A01G 9/042

(57) ABSTRACT

A pot (10) for a plant. The pot (10) may include an inner pot section (12) adapted to receive the plant, an outer pot section (14) adapted to receive the inner pot section (12) and a water collection vessel (16) adapted to be removably fittable between an inner base (32) of the inner pot section (12) and an outer base (18) of the outer pot section (14). The vessel (16) includes a substantially enclosed body (50) with a vessel aperture (52) arranged to align and fit with a drain aperture (44) of the inner base (32) in a fitted condition so as to enable substantially sealed fluid communication therebetween.

### RELATED APPLICATIONS

This application claims priority from PCT international patent application No. PCT/AU2023/050618, filed 4 Jul. 2023, which claims priority from Australian provisional patent application no. 2022901934 filed on 12 Jul. 2022, the contents of which are incorporated by reference in their entirety.

### TECHNICAL FIELD

The invention relates to a pot for a plant. In particular, the invention relates to a pot with a removable water reservoir.

### BACKGROUND

Plant pots are available in a wide range of shapes, sizes and configurations. However, typically, a plant pot includes the main pot in which a plant and associated soil is located and, in some instances, a drip tray underneath. When such plant pots are used indoors, the pot is usually placed on the drip tray, or a fully sealed pot may be used.

A problem with drip trays is that the drip tray may become overfilled and leak. A problem with fully sealed pot relates to water becoming trapped, which in many cases may cause root rot, poor soil conditions for plant health, stale and stagnant water, a breeding ground for insects and damage to the pot material.

To avoid the problem of excess water, owners may reduce the amount of watering they provide the plant: however, underwatering can lead to poor plant health and plant loss. To avoid the problem of leakage, owners may water in small amounts more frequently, which creates inefficiencies and a burdensome chore.

In an attempt to address the problem of excess water, various drainage arrangements for pots have been proposed. One such arrangement is disclosed in AU 2015100899 which includes an inner pot in which a plant and soil are located, an outer pot and a drainage support plate fitted between the inner and outer pot. An open top draw to catch water is located within the outer pot below drainage support plate. The draw may be slid outwardly from a side of the outer pot to be removed and dispose of excess water.

A problem with this pot arrangement includes spillage from the open top draw. Another problem relates to ease of use. Other problems related to indoor plant pots, and the above pot arrangement include more general root health such a root temperature and aeration and the ability to move the pot, which may be relatively heavy once filled with soil and a plant.

The invention disclosed herein seeks to overcome one or more of the above identified problems or at least provide a useful alternative.

### SUMMARY

In accordance with a first broad aspect there is provided, a pot for a plant. The pot may include an inner pot section adapted to receive the plant, an outer pot section adapted to receive the inner pot section and a water collection vessel adapted to be removably fittable between an inner base of the inner pot section and an outer base of the outer pot section, wherein the vessel includes a substantially enclosed body having a neck with a vessel aperture arranged to align and abut with a drain aperture of the inner base in a fitted condition so as to enable substantially sealed fluid communication therebetween.

In an aspect, the neck extends from a top surface of the body and the vessel aperture extends through the neck.

In another aspect, the vessel aperture and the drain aperture are about the same size.

In yet another aspect, the vessel includes a removal means on an outward facing side thereof.

In yet another aspect, an outward facing side of the vessel is shaped to fit with an outward facing side of the outer pot section.

In yet another aspect, an outward facing side of the vessel includes a vessel drain.

In yet another aspect, at least one of the vessel, the outer pot section and the inner pot section include an end of travel stop to locate the vessel in the fitted condition.

In yet another aspect, an outer side wall of the outer pot section is radially spaced apart from an inner side wall of the inner position section so as to provide a gap therebetween.

In yet another aspect, the outer pot section includes an opening in a side wall thereof and the vessel is laterally moveable inwardly and outwardly relative to the side wall between the fitted condition and a removed condition.

In yet another aspect, the pot further includes a root barrier fitted within the inner pot section.

In yet another aspect, the root barrier includes a further drain aperture arranged to align with the drain aperture of the inner pot section.

In yet another aspect, the further drain aperture is smaller than the drain aperture.

In yet another aspect, the root barrier includes a plate body with the drain aperture, the plate body being at least partially spaced apart from and located above the inner base of the inner pot section.

In yet another aspect, the inner pot section is securable within the outer pot section.

In yet another aspect, the inner pot section is adapted to snap fit within the outer pot section.

In yet another aspect, the inner pot section includes a rim arranged to extend over and cover a rim of the outer pot section.

In yet another aspect, the outer base of the outer pot section is adapted to be coupled with friction reducing means.

In yet another aspect, the friction reducing means include wheels.

### BRIEF DESCRIPTION OF THE FIGURES

The invention is described, by way of non-limiting example only, by reference to the accompanying figures, in which;

FIG. 1 is a top perspective view illustrating a pot for a plant with a removeable vessel;

FIG. 2 is a bottom perspective view illustrating the pot with removeable wheels being removed;

FIG. 3 is a front view illustrating the pot with the removeable vessel;

FIG. 4 is a back view illustrating the pot with the removeable vessel;

FIG. 5 is right-hand side view (the left-hand side view being similar) illustrating the pot:

FIG. 6 is a top view illustrating an internal view of the pot:

FIG. 7 is a bottom view illustrating an underside of the pot;

FIG. 8 is a side sectional view illustrating the pot with the removeable vessel;

FIG. 9 is an exploded parts view illustrating the pot with the removeable vessel;

FIG. 10 is a perspective view illustrating the removeable vessel with a front cover thereof removed;

FIG. 11 is a side view illustrating the removeable vessel with the front cover thereof removed:

FIG. 12 a side sectional view illustrating the removeable vessel; and

FIG. 13 is a top view illustrating the removeable vessel with the front cover thereof removed.

### DETAILED DESCRIPTION

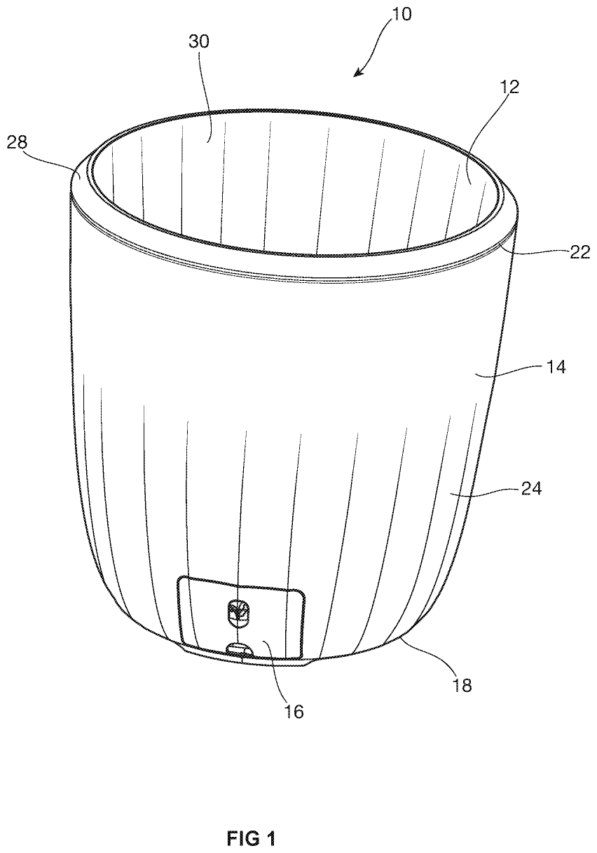

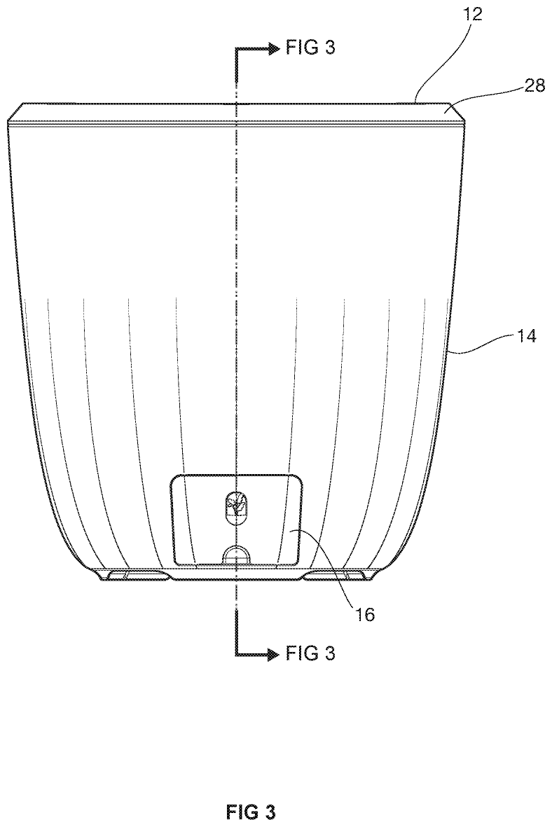

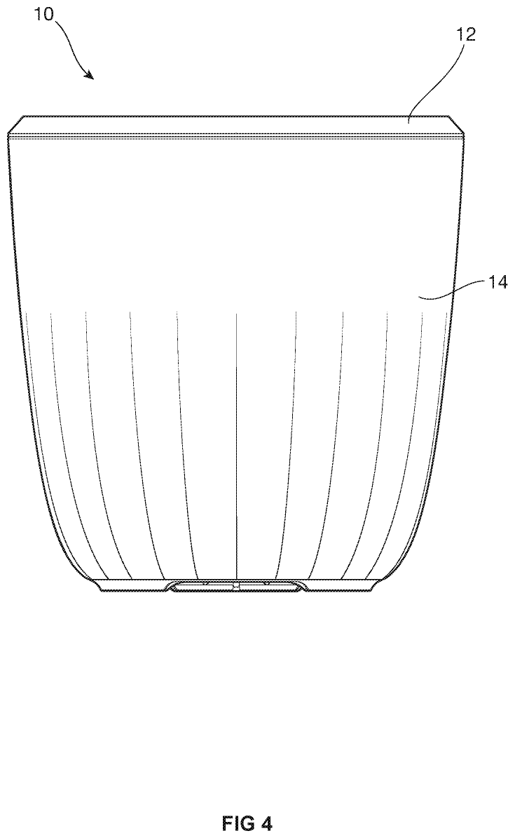

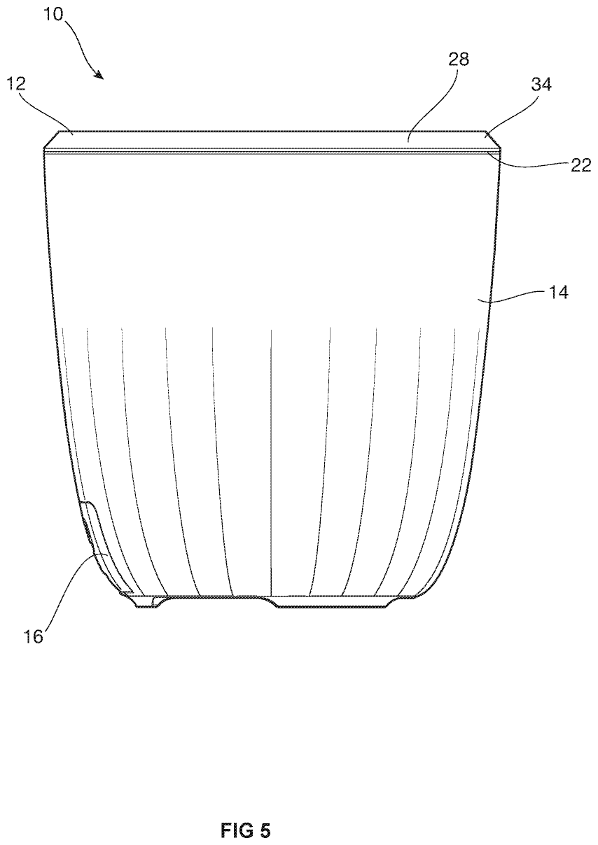

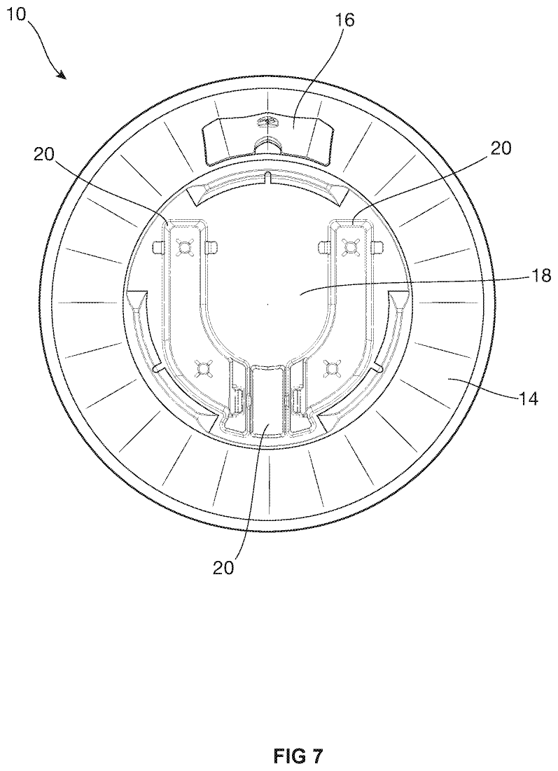

Referring to FIGS. 1 to 7, there is shown a pot or pot arrangement 10 for a plant (not shown). The pot 10 includes an inner pot section 12 adapted to receive the plant, an outer pot section 14 adapted to receive the inner pot section 12 and a removable water collection vessel 16 adapted to be removably fittable between the inner pot section 12 and the outer pot section 14 to capture water draining from the inner pot section 12. The pot 10 may have any suitable shape such as, but not limited to round, curved or rectangular.

The pot or pot arrangement 10 including the inner and outer pot sections 12, 14 may be made of any suitable material such as, but not limited to, plastics, recyclable or recycled plastics, biodegradable materials or other suitable material. The pot or pot arrangement 10 may in some examples be formed as a single piece.

In this example, the outer pot section 14 is generally cylindrical in shape having an outer rim 22 and a skirting side wall 24 that extends from the rim 22 and slightly tapers inwardly to an enclosed outer base 18. The side wall 24 includes a cut out or opening 26 for the removable water collection vessel 16.

The inner pot section 12 is dimensioned to fit within the outer pot section 14 and includes an inner rim 28 and an inner skirting wall 30 extending from the rim 28 to an inner base 32. In this example, the inner rim 28 extends over and covers the outer rim 22 and includes a chamfered surface 35.

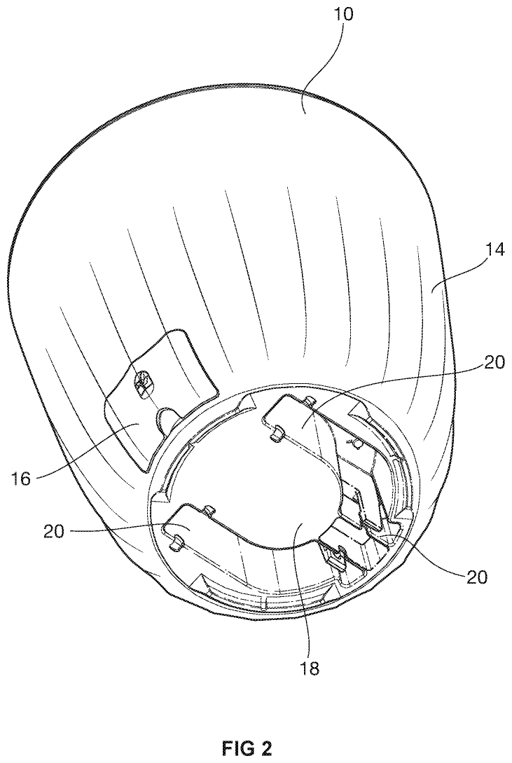

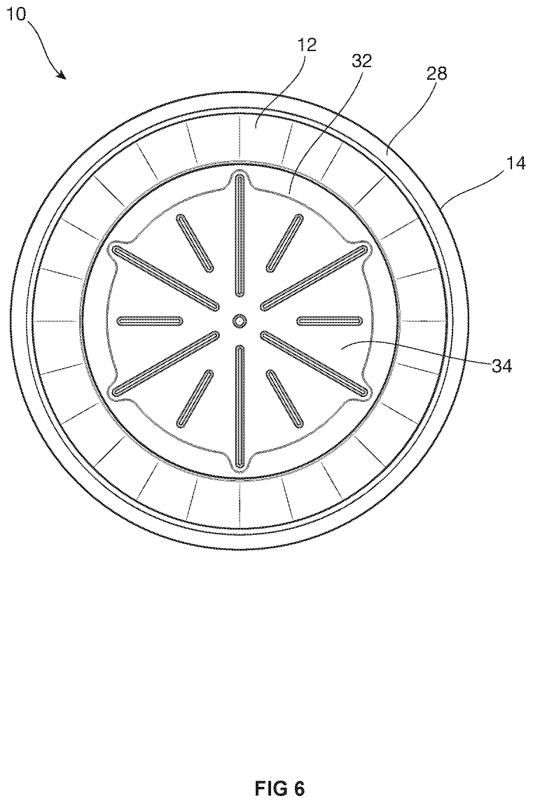

As best shown in FIGS. 2 and 6, the outer pot section 14 includes an outer base 18 that may include adaptations, such as wheel mountings 20 to fit with friction reducing means (now shown) such a castor wheels (not shown) or the like. The inner pot section 12 may be fitted within a root support or barrier 34 shown in FIG. 6.

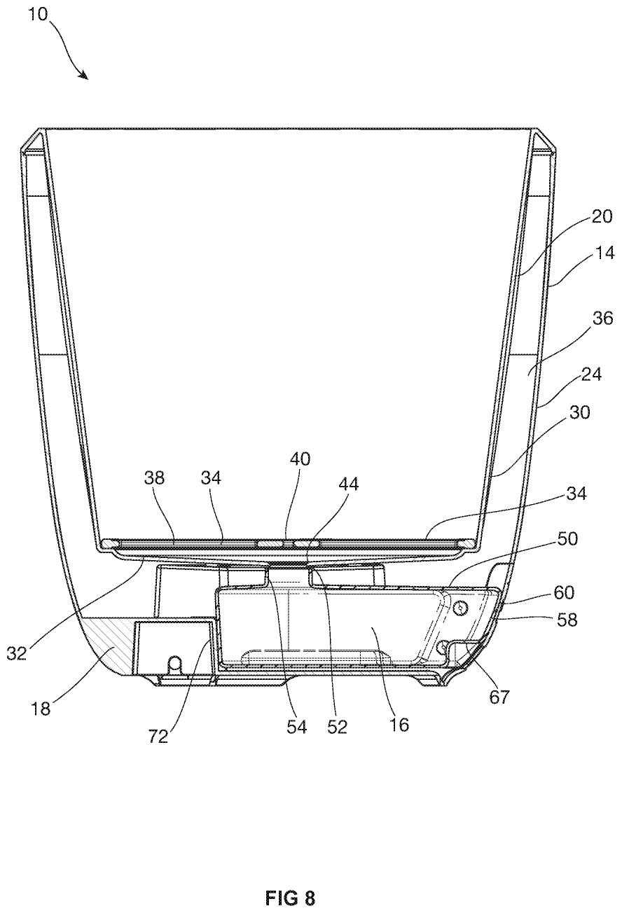

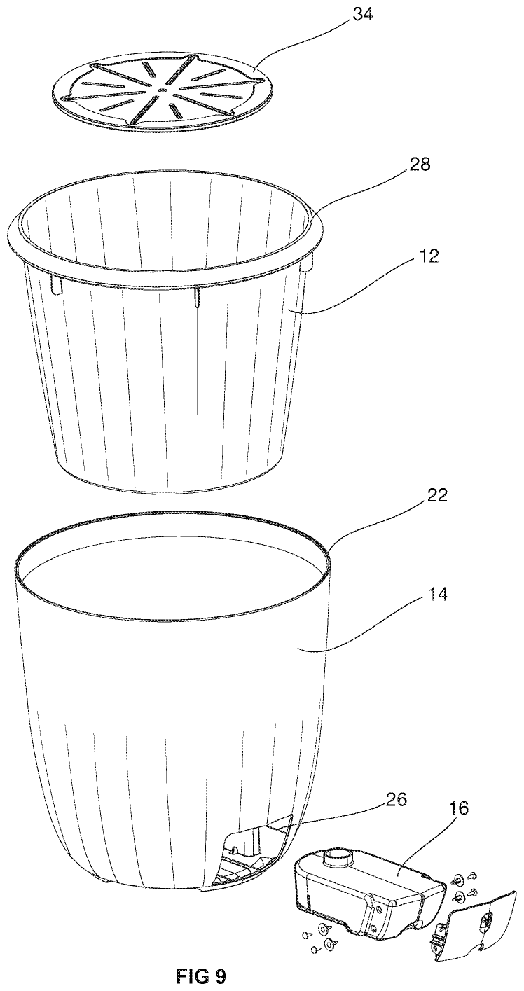

Referring now to FIGS. 8 and 9, the skirting side wall 24 of the outer pot section 14 may be spaced apart from the inner wall 30 of the inner pot section 12 to provide a gap or space 36 therebetween. The gap 36 may be filled with air and provide insulation for the inner pot section 12 and any plant contained therein.

The fit between the inner pot section 12 and the outer potion section 14 may be a snap fit or the like to secure the sections 12, 14 together. The root barrier 34 may be a circular plate 38 with a central drainage aperture 40 and channels 42 leading to the central drainage aperture 40. It is noted that further plates or barriers may be added and may include geofabrics or the like.

The inner pot section 12 includes a central drainage aperture 44 in its base 32. The base 32 is sloped downwardly so that water drains toward the central drainage aperture 44. The root barrier 34 is arranged seat on a ledge 36 and extend over the base 32 with the central drainage aperture 40 of the root barrier 34 above the central drainage aperture 44 of the base 32. The size of the drainage aperture 40 is smaller than the central drainage aperture 44 of the base 32.

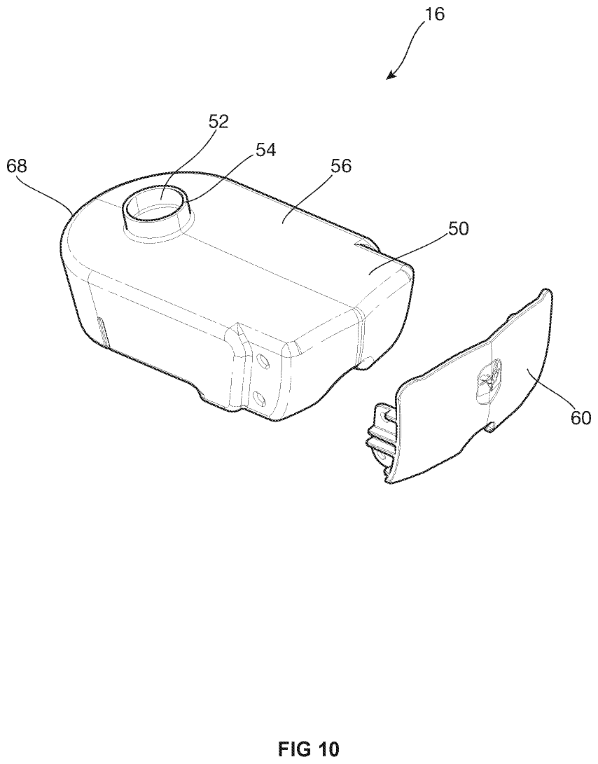

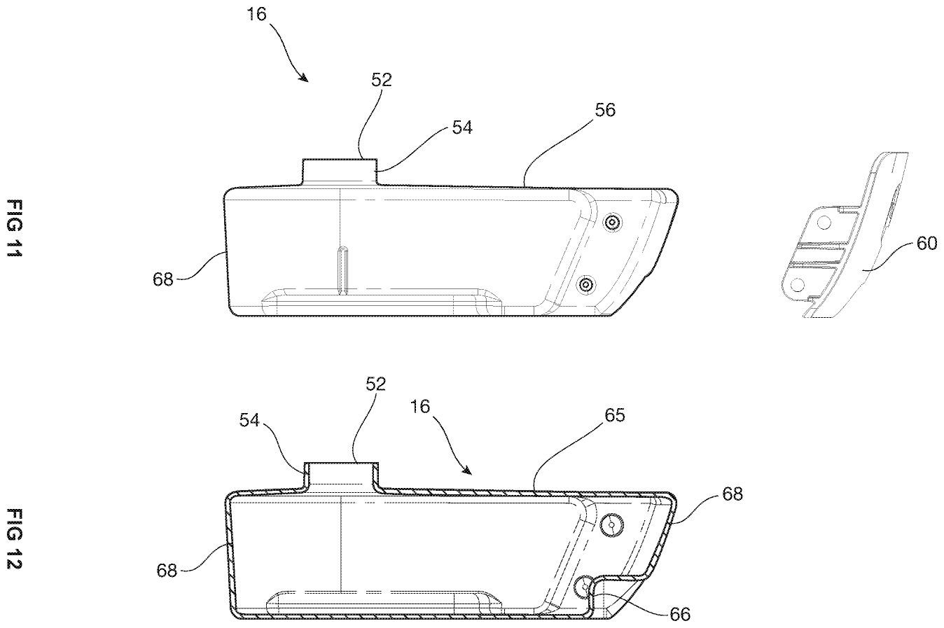

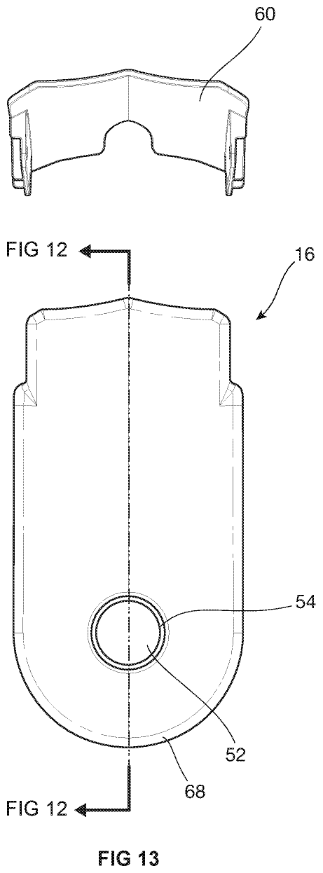

Turning now to the water collection vessel 16 in more detail as shown in FIGS. 9 to 13, the vessel 16 includes a substantially enclosed body 50 with a vessel aperture arranged 52 to align and fit with the drain aperture 44 of the inner base 32 in a fitted condition so as to enable substantially sealed fluid communication therebetween in the fitted condition.

In this example, the vessel 16 includes a neck 54 extending from a top surface 56 of the body 50 and the vessel aperture 52 extends through the neck 54. The vessel aperture 52 and the drain aperture 44 are about the same size, and may substantially abut one another in the fitted condition to generally provide a seal between the drain aperture 44 and the vessel aperture 52.

An outward facing side 58 of the vessel 16 is shaped to fit with the shape of the side wall 24 of the outer pot section 14 to give the pot 10 a generally flush appearance. The outward facing side 58 may include a shaped cover or shell 60 that is connected to the substantially enclosed body 50.

The cover or shell 60 may include a window (not shown) to allow the water level within the body 50 to be viewable from a location outside of the pot 10, and may include an indent 64 to coincide with a recess 66 of the body 50. The body 50 may be clear or have clear parts so that the water level is viewable.

The indent 64 and recesses 66 may provide a removal means 67 in the form of a finger pull, and in some examples a further drainage outlet or tap (not shown) may be provided on the body 50 to allow optional drainage of the body 50 without removal.

An insertion end 68 of the body 50 may be round to assist the vessel 16 to self-locate and orient when inserted and removed from a lateral recess 70 of the pot 10 that extends inwardly from the cut out 26. An end of travel stop 72 may also be provided at or by the outer base 18. In some examples, the pot 10 may be fitted with wheels (not shown) at the mounting mountings 20, or placed into a stand.

The water collection vessel 16, may be made of any suitable material such as, but not limited to, plastics, recyclable or recycled plastics, biodegradable materials or other suitable material. It may be formed as single part or in multiple parts. For example, the top surface 56 of the body 50 may be formed separately and then ultrasonically welded the lower section of body 50.

In use, the inner pot section 12 may be fitted to and coupled within the outer pot section 14, and the root support 34 may be fitted within the inner pot section 12. The vessel 16 may be slid laterally inwardly through the cut out 26. A plant or the like may be located within the inner pot 10 and seated on the root support 34. The plant may be watered, and water may drain into the vessel 16 via its aperture 52 from the drain aperture 44 of the inner base 32.

The fit between the aperture 52 of the vessel 16 and drain aperture 44 assists to minimise leaks by generally providing a sealed conduit or connection therebetween. Once the vessel 16 is sufficiently full, it may be slid outwardly from the recess 70 and emptied as need be. The generally enclosed body 50 further assists to minimise leaks or water spillage, and the neck 54 extending from the body 50 provides a spout from which water may be poured to drain the body 50.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any known matter or any prior publication is not, and should not be taken to be, an acknowledgment or admission or suggestion that the known matter or prior art publication forms part of the common general knowledge in the field to which this specification relates.

While specific examples of the invention have been described, it will be understood that the invention extends to alternative combinations of the features disclosed or evident from the disclosure provided herein.

Many and various modifications will be apparent to those skilled in the art without departing from the scope of the invention disclosed or evident from the disclosure provided herein.

The claims defining the invention are as follows:

1. A pot for a plant, the pot including an inner pot section adapted to receive the plant, an outer pot section adapted to receive the inner pot section and a water collection vessel adapted to be removably fittable between an inner base of the inner pot section and an outer base of the outer pot section, wherein the vessel includes a substantially enclosed body having a neck with a vessel aperture arranged to align and abut with a drain aperture of the inner base in a fitted condition so as to enable substantially sealed fluid communication therebetween.

2. The pot according to claim 1, wherein the neck extends from a top surface of the body and the vessel aperture extends through the neck.

3. The pot according to claim 1, wherein the vessel aperture and the drain aperture are about the same size.

4. (canceled)

5. The pot according to claim 1, wherein the vessel includes a removal means on an outward facing side thereof.

6. The pot according to claim 1, wherein an outward facing side of the vessel is shaped to fit with an outward facing side of the outer pot section.

7. The pot according to claim 1, wherein an outward facing side of the vessel includes a vessel drain.

8. The pot according to claim 1, wherein at least one of the vessel, the outer pot section and the inner pot section include an end of travel stop to locate the vessel in the fitted condition.

9. The pot according to claim 1, wherein an outer side wall of the outer pot section is radially spaced apart from an inner side wall of the inner position section so as to provide a gap therebetween.

10. The pot according to claim 1, wherein the outer pot section includes an opening in a side wall thereof and the vessel is laterally moveable inwardly and outwardly relative to the side wall between the fitted condition and a removed condition.

11. The pot according to claim 1, wherein the pot further includes a root barrier fitted within the inner pot section.

12. The pot according to claim 11, wherein the root barrier includes a further drain aperture arranged to align with the drain aperture of the inner pot section.

13. The pot according to claim 11, wherein the further drain aperture is smaller than the drain aperture.

14. The pot according to claim 11, wherein the root barrier includes a plate body with the drain aperture, the plate body being at least partially spaced apart from and located above the inner base of the inner pot section.

15. The pot according to claim 11, wherein the inner pot section is securable within the outer pot section.

16. The pot according to claim 11, wherein the inner pot section is adapted to snap fit within the outer pot section.

17. The pot according to claim 11, wherein the inner pot section includes a rim arranged to extend over and cover a rim of the outer pot section.

18. The pot according to claim 11, wherein the outer base of the outer pot section is adapted to be coupled with a friction reducing means.

19. The pot according to claim 18, wherein the friction reducing means include wheels.

20. (canceled)
